(19) United States
(12) Patent Application Publication
(10) Pub. No.: US 2019/0049022 A1
(43) Pub. Date: Feb. 14, 2019

(54) FLUID MANIFOLD AND DIRECTION CONTROL VALVE THEREOF

(71) Applicants: Jack Tseng, Burlingame, CA (US); Michael P. Green, Pleasant Hill, CA (US)

(72) Inventors: Jack Tseng, Burlingame, CA (US); Michael P. Green, Pleasant Hill, CA (US)

(21) Appl. No.: 15/672,624

(22) Filed: Aug. 9, 2017

(51) Int. Cl. F16K 11/02

(52) U.S. Cl. CPC F16K 11/02

(57) ABSTRACT

A fluid manifold and a direction control valve are disclosed. The manifold of the present invention comprises a substantially spherical body with an inner space, an inlet port and a plurality of outlet ports. The inlet port and the outlet ports are connected to the inner space of the body. The direction control valve of the present invention further comprises a switching member rotatably disposed in the inner space with a channel for connecting the inlet port with one of the outlet ports.

### FIELD OF THE INVENTION

The present invention is related to a fluid manifold and a direction control valve thereof, more particularly to a fluid manifold with a substantially spherical body and the direction control valve there of.

### BACKGROUND OF THE INVENTION

Various valve constructions and arrangements are known for controlling the flow of gas, liquids or slurries in association with piping and conduits. In certain applications, it can be desirable to provide selective fluid communication between one and more of a plurality of individual pipes intersected by a main pipe. This can be accomplished by providing each of the individual pipes with its own respective isolation valve, or by installing a diverter or “Y” valve in communications with the main feed pipe.

In some applications, it may be desirable to prevent reverse flow through a diverter valve and therefore, suitable flow check mechanisms can be provided so as the fluid only flows in one direction.

Although arrangements of the above description are commonly employed to permit a selected fluid direction of flow, complications sometimes arise due to hostile liquid environments or from obstacles obstruction preventing liquid gravity flow inside a pipe line.

Therefore in many applications, the nature of the fluids being piped and controlled dictates the type of valve suitable for the application. For example, in facilities which handle and treat sewage, the influent flow can often be abrasive or corrosive. Equipment installed in these applications must be specially adapted for rigorous service requirements. Not only does this frequently limit the valve type suitable for use, it can also significantly impact influent flow or even possibly maintenance requirements in which create additional expense for the consumer.

Most sewer systems often operate using gravity fall or what's more commonly referred to within the construction trades as slope or pitch rates. Slope rate is commonly used to evacuate a liquid waste stream from various structures and directs it into a main line or what is more commonly known as a sewer line.

Slope rates are typically dictated by building codes in which state “the rate of slope must be a quarter inch for each one foot of pipe run”. However, field conditions such as utility obstructions or in some case a lack of structural elevation does not always allow for a proper slope angle. In these cases as long as the pipe run maintains a minimal slope angle without any dips, it should still function without too much worry about extensive backup.

Building codes also limit the maximum allowable slope angle to “one foot for every four feet of pipe run”. The limiting of slope is meant to prevent waste water flowing too fast upon entering into a sewer system in which may cause interference of disruption to an existing sewer flow. Also other issues exist when having an extreme amount of slope angle, particularly in regards to household waste water if flowing too fast. In this instance a fast flow can create siphoning resulting in the drying of water barriers held inside sink traps, these barriers are used to prevent sewer gases from entering into the home from the sewer system.

Most patent applications didn't include unique design changes which enhance valve durability or flow efficiency. Mostly, the designs didn't take in consideration about housing size or fluid flow dynamics. Further, most directional valves currently offered affect slope angle due to installation angles required for mating to an existing pipe line or by inlet and outlet height in relationship to pipe line elevation. The current offered directional valves do not offer ground level accessibility for switching a fluid flow direction.

For example, the US patent with patent number of U.S. Pat. No. 4,578,188A (hereinafter as Cousino) teaches a sewage flow diverter comprising a relatively large drain, a weir in the bottom of the drain, an inlet communicating with the drain adjacent the bottom thereof, and upstream of the weir, an outlet communication with the drain downstream from the weir, the opposite ends of the inlet and outlet being adjacent, opening means located between the opposite ends of the inlet and outlet, said opening means so located and sized to permit relatively low flows of liquid in the inlet to pass through the opening and relatively high flows to be propelled by the kinetic energy of the flow form the inlet into the outlet, and means to conduct the flow passing through the opening means to a sanitary interceptor.

Cousino's teachings refer mainly to cases when high sewer flows are of concern and where in low sewer flow situations may inhibit a flow rate based on the design principle of his apparatus.

In another example, The PCT application of WO2010088091 (hereinafter as Dvorak) teaches a system for diverting water comprising: a filter basket; a drain pipe providing a first channel and a second channel; and a diverter capable of diverting water from the filter basket alternatively towards each of the first and second channels.

The invention of Dvorak is reliant upon influent flow through a filter basket in which could be considered flow restrictive and further, if the filter basket requires added maintenance for occasional cleaning would not be cost effective for the consumer.

In another example, the US patent of U.S. Pat. No. 5,423,343A (hereinafter as Crouch) teaches the principle of testing a new sewage main line, the valve assembly is manipulated from above ground without excavation to connect the lateral to the new main line and block off the now unneeded old discharge line. A cable extends from the valve assembly to above ground. Manipulation of the cable rotates the valve to a position enabling flow from the lateral line to the new main line, while at the same time blocking off the old discharge line.

The invention of Crouch is a temporary solution when intersecting two sewer pipes together, wherein a diverter valve is used to check the integrity of a new pipe line.

Most diverter valve internal components are often constructed using some types of plastics or metals or a combination of both. However, the downfalls of most diverter valves are taking in consideration of contaminate types or solids commonly associated with some influent application. For instance, inside sewer systems contaminate types can vary form household chemicals inter-burst with industrial chemicals and solids intermixed within various water streams. These water streams can be often corrosive to both metals and plastics. Moreover, solid buildup within or on internal movable components may cause sticking, seizing or pitting, these contribute to a loss of integrity and eventual fluid bi-passing or external housing leakage.

Metals well known to resist corrosion are often used in construction of a valve system, they often involve two dissimilar metals, for example a copper or bronze housing may be working in conjunction with a stainless steel ball or flap. When these dissimilar metals are exposed to conductive fluids or active electrolytes, bi-metal electrolytic reactions occur. These reactions encourage electrolytic metal erosion which eventually leads to physical damage to both internal and external components.

Consequently, how to provide a fluid manifold and a direction control valve thereof to overcome the drawbacks of the current products is the problem of the community.

### SUMMARY OF THE PRESENT INVENTION

It is an objective of the present invention to provide fluid manifold and a direction control valve thereof, more particularly to a fluid manifold with a substantially spherical body and the direction control valve there of.

It is another objective of the present invention to provide a fluid manifold with a substantially spherical body which required a minimal amount of footprint for installation.

It is still another objective of the present invention to provide a direction control valve with a substantially spherical housing which required a minimal amount of footprint for installation.

It is still another objective of the present invention to provide a direction control valve with a spherical switching member having a channel to connect the inlet port with one of the plurality of outlet ports.

The present invention provides a fluid manifold comprising: a body with an inner space, wherein the body is substantially spherical; an inlet port disposed on the body and connected with the inner space; and a plurality of outlet ports disposed on the body and connected with the inner space.

In one embodiment of the present invention, the inner space is spherical.

In one embodiment of the present invention, the fluid manifold is made of PVC®, ABS®, CPVC®, metal or the combination thereof.

In one embodiment of the present invention, the fluid manifold further comprises a check valve disposed in the inlet port.

In one embodiment of the present invention, the fluid is selectively one of a liquid, a gas, a slurry or the combination thereof.

The present invention further provides a direction control valve comprising: a housing including a body with an inner space, wherein the body is substantially spherical and the inner space is spherical; an inlet port disposed on the body and connected with the inner space; a plurality of outlet ports disposed on the body and connected with the inner space; and a switching member rotatably disposed in the inner space for selectively connecting the inlet port with one of the plurality of outlet ports.

In one embodiment of the present invention, the switching member is spherical and matching to the inner space.

In one embodiment of the present invention, the switching member includes a channel with a first end and a second end, wherein the first end is connected to the inlet port, the second end is selectively connected to one of the plurality of outlet ports.

In one embodiment of the present invention, the channel is smoothly connected between the inlet port and one of the plurality of outlet ports.

In one embodiment of the present invention, each of the plurality of outlet ports includes a predetermined angle with the inlet port.

In one embodiment of the present invention, the direction control valve further comprises a shaft connected to the switching member at a side opposite to the inlet port for driving the switching member to rotate.

In one embodiment of the present invention, the direction control valve further comprises a driving module for driving the switching member to rotate; wherein the shaft passes through the housing and is connected to the driving module.

In one embodiment of the present invention, the driving module is a handle or an automated actuator.

In one embodiment of the present invention, the housing further comprises a sleeve disposed surrounding the shaft.

In one embodiment of the present invention, the sleeve has a flange for fixing the driving module.

In one embodiment of the present invention, the driving module further comprises an extension member.

In one embodiment of the present invention, the extension member is a straight extension member or an angular extension member.

In one embodiment of the present invention, the direction control valve further comprises a check valve disposed in the inlet port.

In one embodiment of the present invention, the direction control valve is made of PVC®, ABS®, CPVC®, metal or the combination thereof.

In one embodiment of the present invention, the channel is coated with a material selected from one of Teflon®, Teflon “S”®, Silverstone®, Supra®, FEP®, Excalibur®. Quantum®, Emralon®, Xylan®, Kynar®, Halar®, ETFE, Tefzel®, Epoxy, Polyester or the combination thereof.

### BRIEF DESCRIPTION OF THE DRAWINGS

FIG. 1 is a sectional view of a fluid manifold in accordance with one embodiment of the present invention.

FIG. 2 is a sectional view of a direction control valve in accordance with one embodiment of the present invention.

FIG. 3 is a top view of a direction control valve in accordance with the embodiment shown in FIG. 2.

FIG. 4 is a sectional view of a direction control valve in accordance with still another embodiment of the present invention.

FIG. 5 is a sectional view of a direction control valve in accordance with still another embodiment of the present invention.

### DETAILED DESCRIPTION OF THE PREFERRED EMBODIMENTS

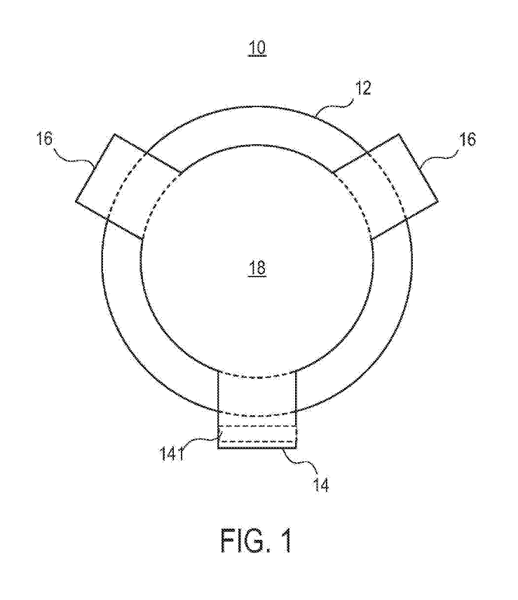

Referring to FIG. 1, there is shown a sectional view of a fluid manifold in accordance with one embodiment of the present invention. The fluid manifold of the present invention comprises a body 12, an inlet port 14 and a plurality of outlet ports 16. The body 12 is substantially spherical and has an inner space 18. The inlet port 14 is disposed on the body 12 and connected with the inner space 18. The plurality of outlet ports 16 are disposed on the body 12 and connected with the inner space 18. When the inlet port 14 of the fluid manifold 10 is connected to a inlet pipe (not shown), a fluid flows from the inlet pipe to the inner space 18 and flows out from the plurality of outlet ports 16. The substantially spherical body 12 of the fluid manifold 10 required a minimal amount of footprint for installation to a pipe system.

In one embodiment of the present invention, the inner space 18 of the body 12 is spherical.

In one embodiment of the present invention, the fluid manifold 10 is made of PVC®, ABS®, CPVC®, metal or the combination thereof.

In one embodiment of the present invention, the fluid manifold 10 further comprises a check valve 141 disposed in the inlet port for preventing the fluid from flowing backward.

In one embodiment of the present invention, the fluid in the present invention is selectively one of a liquid, a gas, a slurry or the combination thereof.

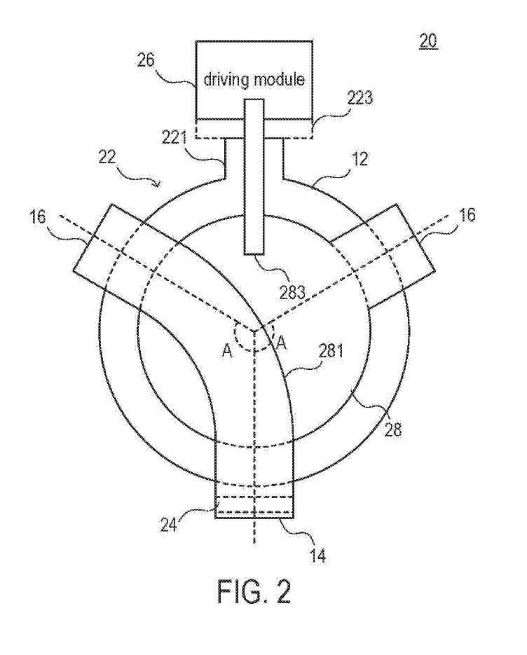

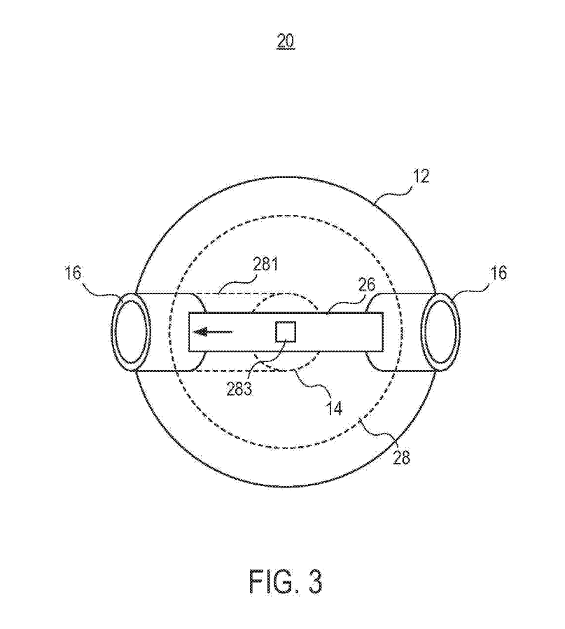

Referring to FIG. 2 and FIG. 3, there are shown a sectional view and a top view of a direction control valve in accordance with one embodiment of the present invention. The direction control valve 20 of the present invention comprises a housing 22, an inlet port 14, a plurality of outlet ports 16 and a switching member 28.

The housing including a body 12 with an inner space, wherein the body 12 is substantially spherical and the inner space is spherical. The inlet port 14 is disposed on the body 12 and connected with the inner space. The plurality of outlet ports 16 are disposed on the body 12 and connected with the inner space. The switching member 28 is rotatably disposed in the inner space for selectively connecting the inlet port 14 with one of the plurality of outlet ports 16. When the inlet port 14 is connected to an inlet pipe (not shown), the fluid from the inlet pipe is selectively conducted to one of the plurality outlet ports 16 by rotating the switching member 28.

In one embodiment of the present invention, the switching member 28 is spherical and matching to the inner space of the housing 22. In the present embodiment, the leakage between components is prevented.

In one embodiment of the present invention, the switching member 28 includes a channel 281 with a first end and a second end. The first end of the channel 281 is connected to the inlet port 14, the second end of the channel 281 is selectively connected to one of the plurality of outlet ports 16 by rotating the switching member 28. In case when the second end of the channel 281 is not connected to any one of the outlet ports 16, the direction control valve is in a closed state.

In one embodiment of the present invention, the channel 281 of the switching member 28 is smoothly connected between the inlet port 14 and one of the plurality of outlet ports 16 with a gentle sweeping radius to reduce the impact of the fluid when changing the direction of the flow.

In one embodiment of the present invention, each of the plurality of outlet ports 16 includes a predetermined angle A with the inlet port 14 to ensure that each of the outlet ports 16 can be exactly connected to the inlet port 14 with the channel 281 by rotating the switching member 28.

In one embodiment of the present invention, the direction control valve 20 further comprises a shaft 283 connected to the switching member 28 at a side opposite to the inlet port 14 for driving the switching member 28 to rotate.

In one embodiment of the present invention, the direction control valve 20 further comprises a driving module 26 for driving the switching member 28 to rotate. The shaft 283 passes through the housing 22 and is connected to the driving module 26.

In one embodiment of the present invention, the driving module 26 is a handle or an automated actuator, such as an electric motor or a solenoid system.

In one embodiment of the present invention, the housing 22 further comprises a sleeve 221 disposed surrounding the shaft 283 for fixing and protecting the shaft 283. Moreover, the leakage between the housing 22 and the shaft 283 can also be prevented.

In one embodiment of the present invention, the sleeve 221 has a flange 223 disposed on the top of the sleeve 221 for fixing the driving module 26. The driving module can be fixed on the flange 223 by bolts and nuts.

In one embodiment of the present invention, the direction control valve 20 further comprises a check valve 24 disposed in the inlet port 14 to prevent the fluid from flowing backward.

In one embodiment of the present invention, the direction control valve 20 is selectively made of one of PVC®, ABS®, CPVC®, metal or the combination thereof.

In one embodiment of the present invention, the channel 281 of the switching member 28 is coated with a material selected from one of Teflon®, Teflon “S”®, Silverstone®, Supra®, FEP®, Excalibur®, Quantum®, Emralon®, Xylan®, Kynart®, Halar®, ETFE, Tefzel®, Epoxy, Polyester or the combination thereof. The coating of Teflon®, Teflon “S”®, Silverstone®, Supra®, FEP®, Excalibur®, Quantum®, Emralon® Teflon® or Xylan® provides function of anti-friction to decrease flow resistance and to prevent contaminate solid buildup. The coating of Teflon “S” ®, Kynar®, Halar®, ETFE, Teflon®/Tefzel® or Epoxy provides function of anticorrosion.

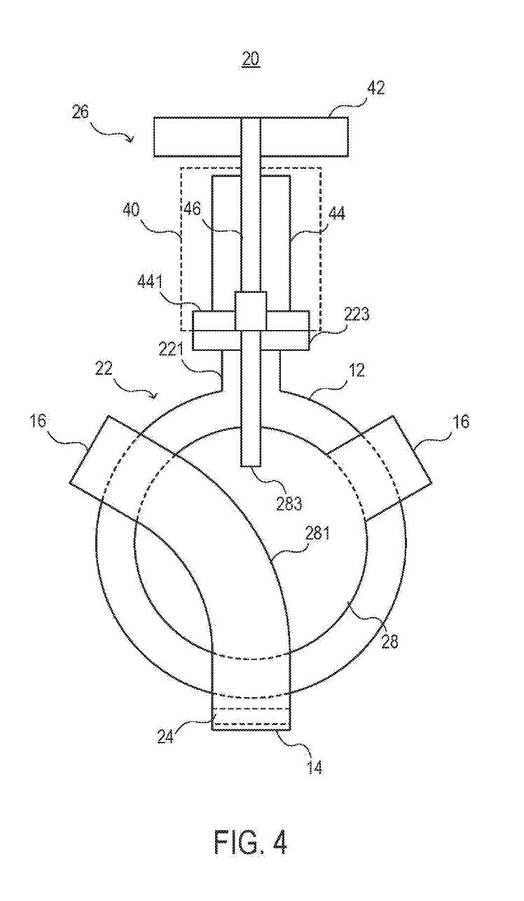

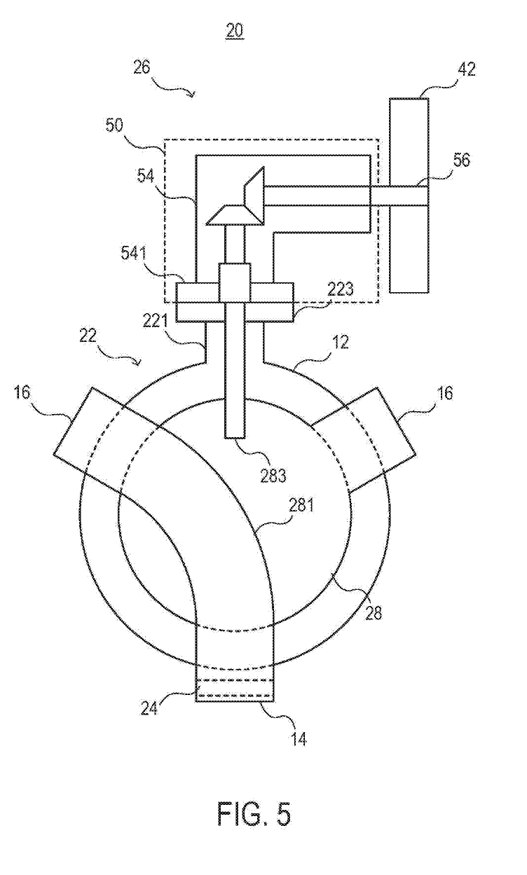

Referring to FIG. 4 and FIG. 5, there are shown sectional views of direction control valves in accordance with other embodiments of the present invention. As shown in the figures, the driving module 26 comprises an extension member 40, 50 and a driving member 42.

In one embodiment of the present invention, the extension member is a straight extension member 40, as shown in FIG. 4. The straight extension member 40 comprises a sleeve 44 with a flange 441 and an extension shaft 46. The flange 441 is fixed to the flange 223 so as to connect the extension shaft 46 to the shaft 283. The driving member 42 is disposed on the extension shaft 46.

In one embodiment of the present invention, the extension member is an angular extension member 50, as shown in FIG. 5. The angular extension member 50 comprises an extension housing 54 with a flange 541 and an angular extension shaft 56. The flange 541 is fixed to the flange 223 so as to connect the angular extension shaft 56 to the shaft 283. The angular extension shaft 56 comprises gear set to provide predetermined angle. The driving member is connected to the angular extension shaft 56.

In one embodiment of the present invention, the driving member 42 is a handle or an automated actuator, such as an electric motor or a solenoid system.

Although particular embodiments of the invention have been described in detail for purposes of illustration, various modifications and enhancements may be made without departing from the scope of the invention specified by the claims.

What is claimed is:

1. A fluid manifold comprising:
a body with an inner space, wherein the body is substantially spherical;
an inlet port disposed on the body and connected with the inner space; and
a plurality of outlet ports disposed on the body and connected with the inner space.

2. The fluid manifold as claimed in claim 1, wherein the inner space is spherical.

3. The fluid manifold as claimed in claim 2, wherein the fluid manifold is made of PVC®, ABS®, CPVC®, metal or the combination thereof.

4. The fluid manifold as claimed in claim 2, further comprising a check valve disposed in the inlet port.

5. The fluid manifold as claimed in claim 2, wherein the fluid is selectively one of a liquid, a gas, a slurry or the combination thereof.

6. A direction control valve comprising:
a housing including a body with an inner space, wherein the body is substantially spherical and the inner space is spherical;
an inlet port disposed on the body and connected with the inner space;
a plurality of outlet ports disposed on the body and connected with the inner space; and
a switching member rotatably disposed in the inner space for selectively connecting the inlet port with one of the plurality of outlet ports.

7. The direction control valve as claimed in claim 6, wherein the switching member is spherical and matching to the inner space.

8. The direction control valve as claimed in claim 7, wherein the switching member includes a channel with a first end and a second end, wherein the first end is connected to the inlet port, the second end is selectively connected to one of the plurality of outlet ports.

9. The direction control valve as claimed in claim 8, wherein the channel is smoothly connected between the inlet port and one of the plurality of outlet ports.

10. The direction control valve as claimed in claim 8, wherein each of the plurality of outlet ports includes a predetermined angle with the inlet port.

11. The direction control valve as claimed in claim 10, further comprising a shaft connected to the switching member at a side opposite to the inlet port for driving the switching member to rotate.

12. The direction control valve as claimed in claim 11, further comprising a driving module for driving the switching member to rotate; wherein the shaft passes through the housing and is connected to the driving module.

13. The direction control valve as claimed in claim 12, wherein the driving module is a handle or an automated actuator.

14. The direction control valve as claimed in claim 12, wherein the housing further comprises a sleeve disposed surrounding the shaft.

15. The direction control valve as claimed in claim 14, wherein the sleeve has a flange for fixing the driving module.

16. The direction control valve as claimed in claim 15, wherein the driving module further comprises an extension member.

17. The direction control valve as claimed in claim 16, wherein the extension member is a straight extension member or an angular extension member.

18. The direction control valve as claimed in claim 6, further comprising a check valve disposed in the inlet port.

19. The direction control valve as claimed in claim 6, wherein the direction control valve is selectively made of one of PVC®, ABS®, CPVC®, metal or the combination thereof.

20. The direction control valve as claimed in claim 6, wherein the channel is coated with a material selected from one of Teflon®, Teflon “S”®, Silverstone®, Supra®, FEP®, Excalibur®, Quantum®, Emralon®, Xylan®, Kynar®, Halar®, ETFE, Tefzel®, Epoxy, Polyester or the combination thereof.
